(19) United States
(12) Patent Application Publication
(10) Pub. No.: US 2016/0065927 A1
(43) Pub. Date: Mar. 3, 2016

(54) VIDEO REPRODUCTION APPARATUS, VIDEO REPRODUCTION METHOD AND VIDEO DISPLAY APPARATUS

(71) Applicants: KABUSHIKI KAISHA TOSHIBA, Tokyo (JP); Toshiba Lifestyle Products & Services Corporation, Tokyo (JP)

(72) Inventor: Miki YAMADA, Ome Tokyo (JP)

(21) Appl. No.: 14/816,954

(22) Filed: Aug. 3, 2015

Related U.S. Application Data
(60) Provisional application No. 62/043,949, filed on Aug. 29, 2014.

(51) Int. Cl. H04N 9/793; H04N 9/87; H04N 9/68

(52) U.S. Cl. CPC H04N 9/7933; H04N 9/68; H04N 9/87

(57) ABSTRACT

According to one embodiment, a video reproduction apparatus calculates two-dimensional coordinate data of an input video signal on a chromaticity diagram, compares the two-dimensional coordinate data calculated with a preset standard color gamut on the chromaticity diagram, determines based on a result of the comparison whether a color gamut corresponding to the input video signal falls within the standard color gamut, adjusts color gamut increase processing and performs the adjusted color gamut increase processing on the input video signal based on a result of the determination.

### CROSS-REFERENCE TO RELATED APPLICATIONS

This application claims the benefit of U.S. Provisional Application No. 62/043,949, filed Aug. 29, 2014, the entire contents of which are incorporated herein by reference.

### FIELD

Embodiments described herein relate generally to a video reproduction apparatus, a video reproduction method and a video display apparatus.

### BACKGROUND

Recent video display apparatuses are able to display, by the employment of a wide color gamut display panel, video images having a wider color gamut (wide gamut: ITU-R BT.2020, referred to as BT.2020) than a standard color gamut (narrow gamut: ITU-R BT.709-3, referred to as BT.709). These apparatuses are able to display video images faithful to materials, exhibiting clean colors, and imparting natural impression. For such a wide-gamut-compliant video display apparatus, a video reproduction apparatus is required to output images without increasing their color gamut, because if the color gamut of video images having a wide gamut obtained by an imaging device having a wide color gamut is further increased, the colors having the video images become too deep, thereby degrading the image quality. Further, if video images having a narrow gamut obtained by an imaging device having a narrow color gamut are directly output, the color gamut and/or performance of a display apparatus having a wide-color gamut signal standard cannot be fully realized, thereby displaying video images lacking vividness. Therefore, in this case, it is desirable to perform appropriate color gamut increase processing.

As described above, in video reproduction apparatuses, there is a demand for displaying many video images in a wide color gamut by selectively increasing the color gamut in accordance with the original color gamut in which a video image corresponding to an input video signal was obtained. However, at present, attribute information associated with a video signal does not include original color information. Further, even if original color information is added in future, it is not guaranteed that the information will be always correct. Thus, in conventional video reproduction apparatuses, it is difficult to automatically set an appropriate color space by real-time processing to thereby reproduce video images created under various color gamut setting conditions.

### BRIEF DESCRIPTION OF THE DRAWING

A general architecture that implements the various features of the embodiments will now be described with reference to the drawings. The drawings and the associated descriptions are provided to illustrate the embodiments and not to limit the scope of the invention.

FIG. 1 is a block diagram showing a system configuration in which a video reproduction apparatus according to embodiments is employed;

FIG. 2 is a block diagram showing the configuration of a video color gamut correcting unit employed in a video reproduction apparatus according to a first embodiment;

FIG. 3 is a flowchart showing a procedure of color gamut increase processing performed by the video color gamut correcting unit of FIG. 2;

FIG. 4 is a conceptual diagram showing a color gamut indicated by an input video signal;

FIG. 5 is a conceptual diagram showing a state in which a video signal of a color gamut of BT.709 is converted into a video signal having a wide color gamut;

FIG. 6 is a conceptual diagram showing the color gamut of a video display unit included in the system of FIG. 1;

FIG. 7 is a conceptual diagram showing a method of discriminating the inside and outside of a color gamut;

FIG. 8 is a conceptual diagram showing chromaticities of the color gamut inside and the color gamut outside;

FIG. 9 is a conceptual diagram showing the ratio of the color gamut outside;

FIG. 10 is a conceptual diagram for comparing the accumulated chromaticities of a color gamut inside and a color gamut outside that are each obtained by combining a plurality of bins;

FIG. 11 is a block diagram showing the configuration of a video color gamut correcting unit employed in a video reproduction apparatus according to a second embodiment;

FIG. 12 is a flowchart showing a procedure of color gamut increase processing performed by the video color gamut correcting unit of FIG. 11;

FIG. 13 is a conceptual diagram showing a predetermined color range (bin) on a chromaticity diagram;

FIG. 14 is a conceptual diagram showing a histogram of image frames expressed using the ratio;

FIG. 15 is a block diagram showing a modification of the video color gamut correcting unit employed in the video reproduction apparatus of the second embodiment;

FIG. 16 is a block diagram showing the configuration of a video color gamut correcting unit employed in a video reproduction apparatus according to a third embodiment; and

FIG. 17 is a flowchart showing a procedure of color gamut increase processing performed by the video color gamut correcting unit of FIG. 16.

### DETAILED DESCRIPTION

Various embodiments will be described hereinafter with reference to the accompanying drawings. In general, according to one embodiment, a video reproduction apparatus comprises: a chromaticity diagram coordinate calculator which calculates two-dimensional coordinate data of an input video signal on a chromaticity diagram; a color gamut determining unit which compares the two-dimensional coordinate data calculated by the chromaticity diagram coordinate calculator, with a preset standard color gamut on the chromaticity diagram, and determines, based on a result of the comparison, whether a color gamut corresponding to the input video signal falls within the standard color gamut; and a color gamut increasing unit which adjusts color gamut increase processing and performs the adjusted color gamut increase processing on the input video signal, based on a determination result of the color gamut determining unit.

### First Embodiment

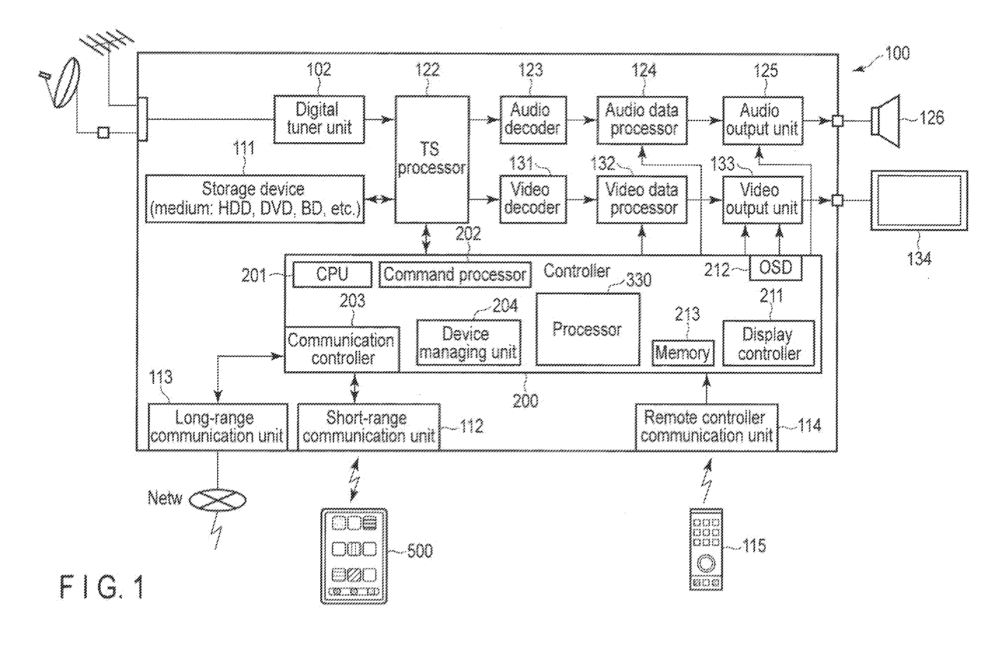

FIG. 1 is a block diagram showing a configuration example of a system 100 (a television receiver or a personal computer) to which a first embodiment is applied. A digital tuner unit 102 includes, for example, a tuner for receiving a scrambled digital celestial broadcast signal, a tuner for receiving satellite (BS/CS) broadcast signals, etc.

The digital tuner unit 102 inputs, to a TS processor 122, obtained transport streams (TS) corresponding to a plurality of channels. Each TS includes a packet sequence associated with a broadcast program corresponding to a channel. There is a packet including, for example, control information.

The TS processor 122 multiplexes a plurality of TSs corresponding to a plurality of channels to form one TS. The multiplexed TS includes packet sequences corresponding to the broadcast programs of the channels. A packet corresponding to each channel additionally includes identification information for channel and packet identification.

The multiplexed TS is input to and stored in a storage unit 111. The packets containing control information and included in the TSs input to the TS processor 122 are further input to and processed by a controller 200.

The storage unit 111 includes, for example, a hard disk drive and an optical disk recording/reproducing unit. The optical disk includes a digital versatile disk (DVD (trademark)), a blue-ray disk (BD (trademark)), etc.

The control information contained in a packet sent from the TS processor 122 to the controller 200 includes, for example, an entitlement control message (ECM) as encrypted information of broadcast programs, an event information table (EIT) showing event information, such as program names, performers and start times, and an electronic program guide (EPG).

Video data contained in a packet is already encoded utilizing, for example, Moving Picture Expert Group (MPEG) or advanced video coding (AVC). Further, audio data in an audio packet is already encoded by, for example, pulse code modulation (PCM), Dolby scheme or MPEG.

The TS processor 122 can select a TS from the storage unit 111 or the digital tuner unit 102 to perform reproduction, based on a control signal from the controller 200. In other words, the TS processor 122 can separate an audio packet containing audio data associated with a program to be reproduced, from a video packet containing video data associated with the program, based on the control signal from the controller 200.

The audio packet containing the audio data and separated from the packet sequence by the TS processor 122 is input to an audio decoder 123, where decoding corresponding to the encoding scheme is performed. The audio data decoded by the audio decoder 123 is sent to an audio data processor 124, where synchronization processing, volume adjustment, etc., are performed. The resultant data is supplied to an audio output unit 125. The audio output unit 125 performs, for example, stereoscopic separation processing corresponding to a speaker system employed, and supplies an output to a loud speaker 126.

The video packet containing video data and separated from a packet sequence by the TS processor 122 is input to a video decoder 131, where decoding corresponding to the encoding scheme is performed. The video data decoded by the video decoder 131 is sent to a video data processor 132, where synchronization processing, luminance adjustment, color adjustment, etc., are performed. The video data processor 132 functions as a video reproduction apparatus according to the first embodiment, and comprises a color gamut correcting unit 1 that determines the color gamut of video data, and corrects the color gamut based on the result of the determination. The output of the video data processor 132 is sent to a video output unit 133.

For instance, the video output unit 133 can superimpose, upon a main video signal, data, figure and a program table sent from the controller 200. Further, the video output unit 133 sets, for an output video signal, scale, resolution, the number of lines, aspect ratio, etc. corresponding to a display 134, and outputs them to the display 134. The display 134 is a video display apparatus compliant with a wide color gamut.

There is a case where an audio packet and a video packet for a pay program are encrypted. In this case, a processing system for decrypting the encryption using key information is also used. However, description of this system is omitted.

The controller 200 comprises a central processing unit (CPU) 201, a command processor 202, a communication controller 203, a device managing unit 204, a display controller 211, an on-screen display (OSD) block 212, a memory 213, etc.

The controller 200 also comprises an EPG data processor for generating a program table signal using EPG data, and a recording/reproducing controller (not shown in FIG. 1) for recording a signal on the storage unit 111 or reproducing a signal from the unit 111 (not shown in FIG. 1).

The CPU 201 performs adjustment of the entire operation sequence of the controller 200. The command processor 202 can analyze externally input operation commands and reflect operations corresponding to the commands in the television receiver 100. The device managing unit 204 stores device identification data associated with a mobile terminal 500, a remote controller 115, etc., that supply operation signals to the controller 200.

The display controller 211 can supply a program table signal or a menu video signal to the video output unit 133 via the OSD block 212. The display controller 211 can also perform adjustment processing associated with the resolution of an image signal, a display size, a display area, etc.

The memory 213 can store various types of data and applications, etc., to be stored within the controller 200.

The communication controller 203 can communicate with external devices to obtain operation commands, data, content, etc. The obtained content and data can be stored in, for example, the storage unit 111 or the memory 213. The communication controller 203 can transmit data, content, etc., from the electronic device 100 to external devices. For instance, the communication controller 203 can transmit data on a program list generated by a processor 330 to an external mobile terminal 500, such as a smartphone or a tablet.

The communication controller 203 is connected to a receiver (a short-range communication unit 112 and a long-range communication unit 113). The short-range communication unit 112 can transmit and receive data to and from the mobile terminal 500, and is used for short-range communication. By inputting an instruction to the instruction input unit of the mobile terminal 500, the operation of the system 100 can be controlled. The mobile terminal 500 can receive a program list generated by the processor 330, as well as video and audio data, and can display them.

The long-range communication unit 113 can transmit and receive data via the Internet to and from a remote server, a home server or a cloud server. The long-range communication unit 113 communicates with, for example, the remote server via radio or via a fixed line (an optical cable, a local area network). The remote server has a receiver for receiving a command signal from the remote communication unit 113.

The system 100 can also receive an operation signal from the remote controller 115 via a receiver (remote controller communication unit 114). The remote controller 115 has an instruction input unit, like the mobile terminal 500.

The mobile terminal 500 can access a server via a base station (not shown), the Internet, etc. It can download various types of applications, game software, etc. from the server, as well as the content served by the server, and transfer them to the controller 20 via the short-range communication unit 112.

The mobile terminal 500 can also transfer information (such as a web server address, a mail address and a network address), used to obtain content and various types of served information, to the controller 200 via the short-range communication unit 112. The mobile terminal 500 may transfer, for example, the web server address, the mail address and the network address to the controller 200 via a base station or a network Netw.

Utilizing the above-mentioned web server, mail address, etc., the communication controller 203 can obtain information associated with, for example, a program.

When content, an application or game software is transferred from the mobile terminal 500, the communication controller 203 included in the controller 200 operates.

The communication controller 203 stores the received content in the memory 213. The content may be stored in the storage unit 111 in accordance with an operation command or automatically. In the storage unit 111, the received content is recorded in, for example, a hard disk. In the hard disk, the content is managed as a content file.

A display menu video signal, a program table signal, etc., are controlled by the display controller 211. When a menu or a program table is displayed, menu screen data or the program table signal is read from the OSD block 212 and sent to the video output unit 133 under the control of the display controller 211. As a result, the menu or the program table is displayed on the display 134. The menu screen data or program table signal may be read from a data storage unit (memory or hard disk) under the control of the display controller 211.

The display menu video signal, the program table signal, etc., can also be transmitted to the mobile terminal 500. When the mobile terminal 500 has requested the menu video signal, the program table signal, etc., the display controller 211 can transmit the menu video signal, the program table signal, etc., to the mobile terminal 500.

The mobile terminal 500 can display the menu video signal and the program table video signal on a touch panel screen. By touching a button displayed on the touch (pointer) panel screen, a user can supply an operation instructing signal to the electronic device.

The controller 200 further comprises a processor 300 (that has a function of generating a program list, and a storage control function of storing, in the memory 213, program information associated with preference information).

The processor 330 stores, in the memory 213, program information extracted from program table information and indicative of a plurality of programs associated with a predetermined preference. For instance, the processor 330 rearranges programs to be broadcasted in a decreasing order of user preference degree, based on EPG data and predetermined preference information, and stores information indicative of the order of program preference in the memory 213. The predetermined preference information is information associated with, for example, a user's program viewing history, an external information search history, a shopping history, a history of communication using, for example, email, and text or images uploaded to the Internet by the user. The EPG data may be extracted from a TS obtained by a tuner, or be obtained from an external server via a network. The information stored in the memory 213 may be updated, for example, when a broadcast program is being viewed, or whenever a recorded program has been replayed. Further, the information may be updated regularly and automatically, or manually in accordance with a user's instruction.

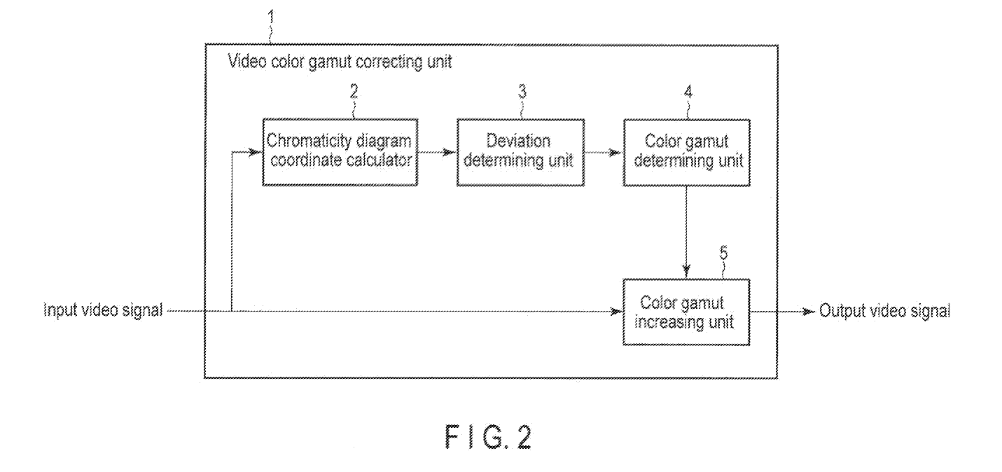

Referring now to FIGS. 2 to 10, a description will be given of video color gamut correction performed by the video reproduction apparatus (the video data processor 132 in FIG. 1) of the first embodiment employed in the above-constructed system 100.

FIG. 2 is a block diagram showing the configuration of the video color gamut correcting unit 1 of the video reproduction apparatus according to the first embodiment. As shown in FIG. 2, the video color gamut correcting unit 1 comprises a chromaticity diagram coordinate calculator 2, a deviation determining unit 3, a color gamut determining unit 4 and a color gamut increasing unit 5.

The chromaticity diagram coordinate calculator 2 calculates two-dimensional coordinates on a chromaticity diagram corresponding to an input video signal. The deviation determining unit 3 determines whether the two-dimensional coordinates calculated by the chromaticity diagram coordinate calculator 2 fall within or outside a preset BT.709 color gamut on a color gamut diagram. The color gamut determining unit 4 determines whether the color gamut corresponding to the input video signal is a predetermined color gamut, based on the determination result of the deviation determining unit 3. The color gamut increasing unit 5 adjusts a color gamut increasing method to perform color gamut increase processing on the input video signal, based on the determination result of the color gamut determining unit 4.

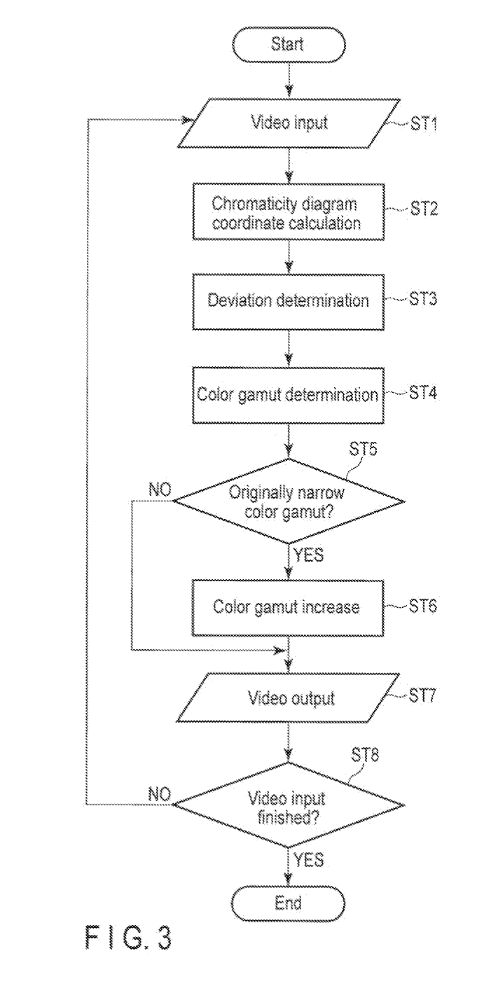

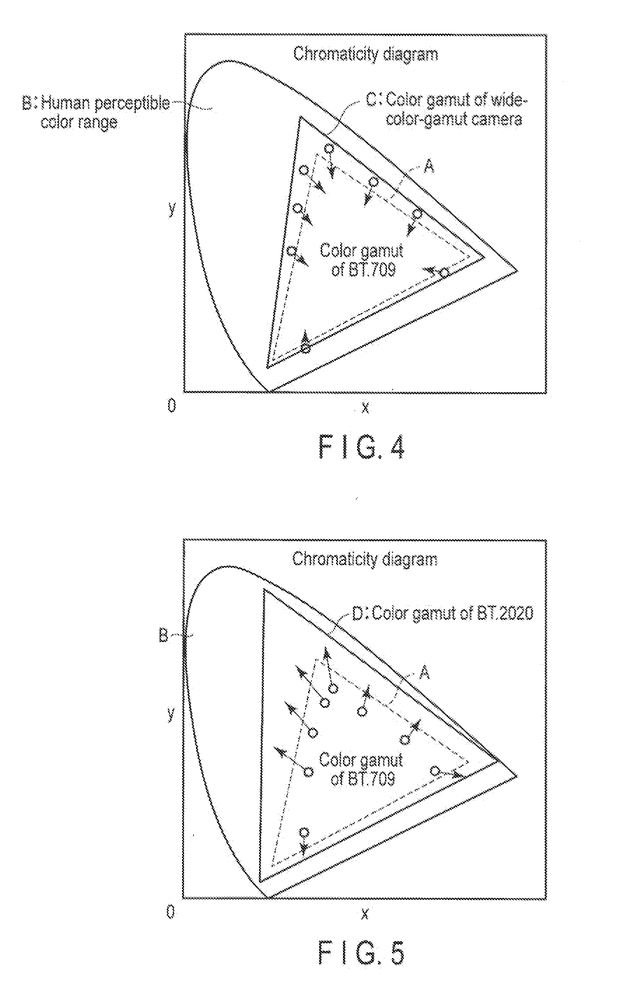

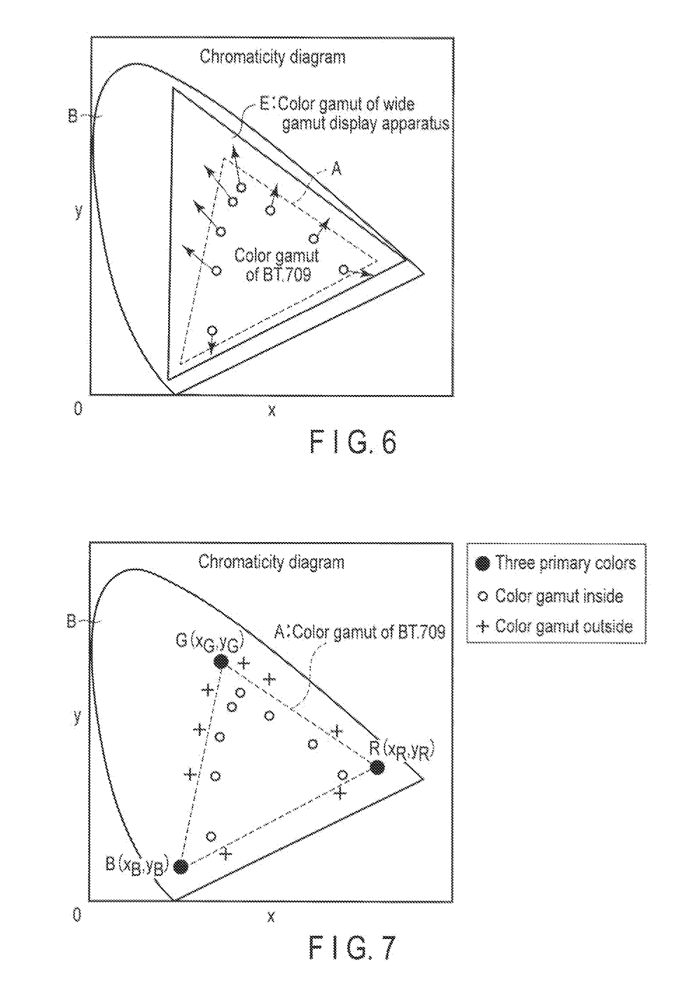

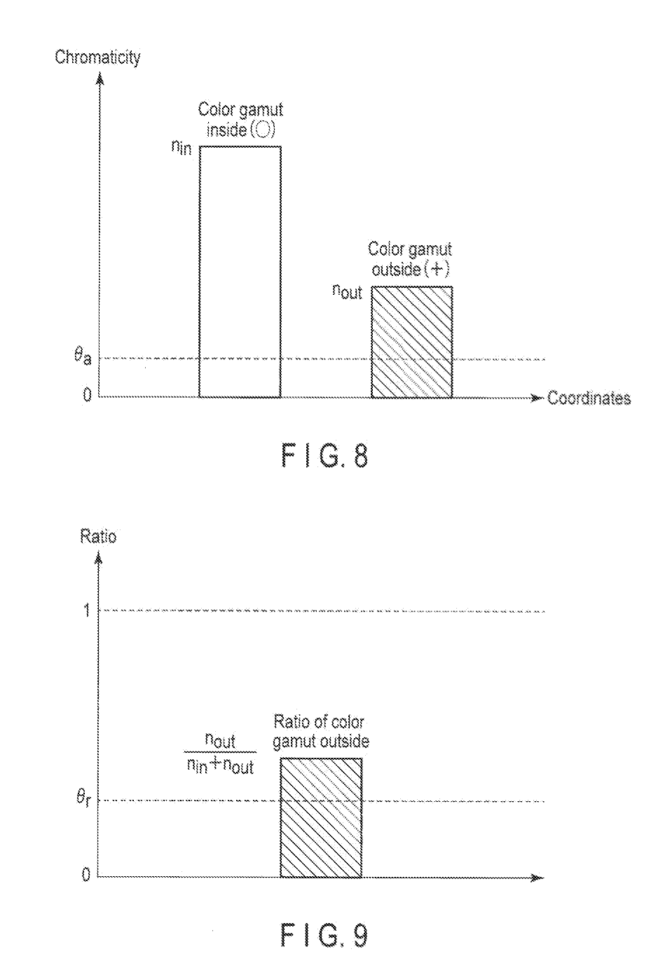

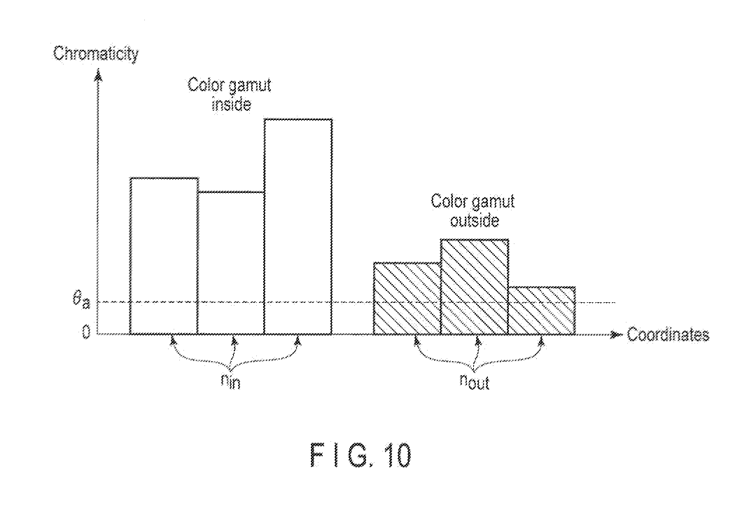

Referring then to FIGS. 3 to 10, a description will be given of color gamut increase processing, according to the first embodiment, performed by the video color gamut correcting unit 1 constructed as the above. FIG. 3 is a flowchart showing a procedure of color gamut increase processing performed by the video color gamut correcting unit 1 shown in FIG. 2. FIG. 4 is a conceptual diagram showing a color gamut indicated by an input video signal. FIG. 5 is a conceptual diagram showing a state in which the color gamut indicated by the video signal is increased. FIG. 6 is a conceptual diagram showing the color gamut of a video display unit (display 134). FIG. 7 is a conceptual diagram showing a method of discriminating the inside and outside of a color gamut. FIG. 8 is a conceptual diagram showing chromaticities of the color gamut inside and the color gamut outside. FIG. 9 is a conceptual diagram showing the ratio of the color gamut outside. FIG. 10 is a conceptual diagram for comparing accumulated chromaticities of the color gamut inside and outside that are each obtained by combining a plurality of bins.

In FIG. 3, in step ST1, it is determined whether there is a video signal input in the video color gamut correcting unit 1. The video signal comprises a plurality of pixels and a plurality of time-series frames. Assuming that the width is given by w pixels, and the height is given by h pixels, the total number of pixels Np is obtained by

Nₚ=wh (1)

Further, one pixel has three components (pixel values), and is expressed using three components of Y, Cb and Cr, or of R, G and B. Each component is expressed by a digital signal with an accuracy of about 8 bits to 16 bits.

After determination as to the input of a video signal in step ST1, the program proceeds to step ST2. In step ST2, the chromaticity diagram coordinate calculator 2 calculates the coordinates, on the chromaticity diagram, of each pixel of the input video signal, the coordinates corresponding to the pixel values. Chromaticity diagrams include CIExy chromaticity diagram, a UCS chromaticity diagram, etc. In the embodiment, a chromaticity diagram, in which the color gamut is expressed by the internal area of a triangle defined using three primary colors (RGB) as vertexes, is used for calculating coordinates thereon.

The term “color gamut” means a color range that can be expressed, and the color gamut differs among different input/output devices and different standards of video signals. As a typical standard color gamut, there is a so-called narrow gamut of BT.709 (more specifically, ITU-R BT.709-3). The triangular range A indicated by the broken line in FIG. 4 indicates the color gamut of BT.709 on a chromaticity diagram. FIG. 4 shows a CIExy chromaticity diagram, in which the inside of figure B of a horseshoe shape is a human perceptible color range, and the upwardly projecting boundary curve expresses a plain color (a color of a single wavelength). The color gamut of an input/output device or a video signal (FIG. 4 shows a color gamut example of a wide color-gamut camera) can be expressed by triangle C on the chromaticity diagram, and the vertexes of the triangle C express three primary colors RGB.

A video signal obtained by a camera of a color gamut equal to in scale or narrower than the BT.709 gamut is directly transmitted and recorded as a BT.709 signal. However, the natural world also contains colors outside the BT.709 gamut, and if these colors are photographed, they are recorded not as achroma but as some colors. This can be considered because the color gamut is recorded, compressed. Further, in a video image obtained by a camera having a wider color gamut than BT.709, the color gamut is compressed and recorded by a method unique to the camera system itself.

C in FIG. 4 expresses the color gamut of a wide gamut camera, and marks “o” and the arrows indicate that the colors in a wider color gamut than the BT.709 color gamut are compressed, and are recorded in the BT.709 color gamut. Namely, the colors obtained by the wide gamut camera and falling outside the BT.709 color gamut are compressed into the BT.709 color gamut, and the resultant colors are transferred and recorded. In contrast, when the compressed colors are displayed in a wide color gamut display apparatus, they are subjected to color gamut increase processing that utilizes, instead of simple linear conversion, appropriate nonlinear conversion based on the above-described compression method information. As a result, more faithful and preferable display is realized.

In addition, when a video image obtained by the wide color gamut camera is transferred as a video signal corresponding to a video signal standard (e.g., BT.2020) having a wider color gamut than BT.709, it is not compressed but is directly transferred and recorded. Similarly, a video image recorded based on BT.709 has its color range increased, whereby it is converted into a video signal having a wide color range (i.e., into a color gamut increased signal), and is transferred and recorded.

FIG. 5 shows a state in which a video signal of the BT.709 color gamut is converted into a video signal having a wide color gamut. In FIG. 5, A indicates the BT.709 color gamut, B indicates a human perceptible color range, and D indicates the BT.2020 color gamut. Marks “o” and the arrows indicate that the colors obtained by a BT.709 camera are subjected to color gamut increase and are recorded.

FIG. 6 shows a state in which a video signal of the BT.709 color gamut has its color gamut increased in accordance with a video display apparatus having a wide color gamut. In FIG. 6, A indicates the BT.709 color gamut, B indicates a human perceptible color range, and E indicates the BT.2020 color gamut. Marks “o” and the arrows indicate that the colors in the BT.709 color gamut are subjected to color gamut increase and are displayed.

After chromaticity diagram coordinate calculation is finished in step ST2, the program proceeds to step ST3. In step ST3, it is determined whether the input video signal falls within or outside a narrow gamut, such as BT.709, in the deviation determining unit 3. FIG. 7 shows pixel values of a wide gamut video signal on a chromaticity diagram, marks “o” indicating pixel values within the color gamut of BT.709, and marks “+” indicating pixel values outside the same.

Whether within or outside the color gamut of BT.709, it can be determined from inequalities that use the coordinates (xᵢ, yᵢ) of each pixel value on the gamut diagram, and equations corresponding to three straight lines (RG, GB, BR). Assuming that the coordinates of R, G and B are (x_{R}, y_{RR}), (x_{G}, y_{G}) and (x_{B}, y_{B}), the straight line passing points R and G is expressed by coordinates (x, y) that satisfy the following equations (2) to (4). Accordingly, colors (xᵢ, yᵢ) outside the color gamut satisfy the following inequality (5), and the colors (xᵢ, yᵢ) within the color gamut satisfy the following inequality (6).

$$\begin{matrix}y = {a}_{RG} x + {b}_{RG} & ( 2 ) \\ {a}_{RG} = \frac{{y}_{R} - {y}_{G}}{{x}_{R} - {x}_{G}} & ( 3 ) \\ {b}_{RG} = \frac{{x}_{R} {y}_{G} - {x}_{G} {y}_{R}}{{x}_{R} - {x}_{G}} & ( 4 ) \\ {y}_{i} > {a}_{RG} {x}_{i} + {b}_{RG} ( outside gamut ) & ( 5 ) \\ {y}_{i} \leq {a}_{RG} {x}_{i} + {b}_{RG} ( within gamut ) & ( 6 )\end{matrix}$$

where the inequality (5) is a sufficient condition required for the colors (xᵢ, yᵢ) to fall outside the color gamut, and the inequality (6) is a necessary condition required for the colors (xᵢ, yᵢ) to fall within the color gamut. Note that the inequalities (5) and (6) are associated with a case where y assumes a lower value with respect to the straight lines expressed by (5) and (6) falls within the color gamut. In contrast, if y assumes a higher value within the triangle defined by the straight lines, the inequality signs are inversed.

Similarly, with respect to the straight line passing through points G and B, the following arithmetic expressions (7) to (11) are used to discriminate the inside and outside of the color gamut. With respect to the straight line passing through points B and R, the following arithmetic expressions (12) to (16) are used to discriminate the inside and outside of the color gamut. In conclusion, if any one of the inequalities (5), (10) and (15) is satisfied, the point (xᵢ, yᵢ) falls outside the color gamut, and if not, the point (xᵢ, yᵢ) falls within the same. In other words, all of the inequalities (6), (11) and (16) are satisfied, the point (xᵢ, yᵢ) falls outside the color gamut, and if not, the point (xᵢ, yᵢ) falls within the same.

$$\begin{matrix}y = {a}_{GB} x + {b}_{GB} & ( 7 ) \\ {a}_{GB} = \frac{{y}_{G} - {y}_{B}}{{x}_{G} - {x}_{B}} & ( 8 ) \\ {b}_{GB} = \frac{{x}_{G} {y}_{B} - {x}_{B} {y}_{G}}{{x}_{G} - {x}_{B}} & ( 9 ) \\ {y}_{i} > {a}_{GB} {x}_{i} + {b}_{GB} ( outside gamut ) & ( 10 ) \\ {y}_{i} \leq {a}_{GB} {x}_{i} + {b}_{GB} ( within gamut ) & ( 11 ) \\ y = {a}_{BR} x + {b}_{BR} & ( 12 ) \\ {a}_{BR} = \frac{{y}_{B} - {y}_{R}}{{x}_{B} - {x}_{R}} & ( 13 ) \\ {b}_{BR} = \frac{{x}_{B} {y}_{R} - {x}_{R} {y}_{B}}{{x}_{B} - {x}_{R}} & ( 14 ) \\ {y}_{i} < {a}_{BR} {x}_{i} + {b}_{BR} ( outside gamut ) & ( 15 ) \\ {y}_{i} \geq {a}_{BR} {x}_{i} + {b}_{BR} ( within gamut ) & ( 16 )\end{matrix}$$

As described above, in step ST3, it is determined whether the point (xᵢ, yᵢ) obtained by mapping each pixel value of a video signal on the chromaticity diagram falls within or outside the color gamut, thereby calculating the chromaticity of the point, and transmitting information indicative of the calculation result to the color gamut determining unit 4, followed by the program proceeding to step ST4.

In step ST4, the color gamut corresponding to the input video signal is determined in the color gamut determining unit 4, using the calculation result information received from the deviation determining unit 3. Assuming that the chromaticity indicated by the pixel value determined to fall within a narrow color gamut is calculated and set as nᵢₙ, and the chromaticity indicated by the pixel value determined to fall outside the narrow color gamut is calculated and set as nₒᵤₜ, if nₒᵤₜ is greater than θₐ (see FIG. 8), and if nₒᵤₜ/(nᵢₙ+nₒᵤₜ) is greater than θᵣ (see FIG. 9), it is determined that the input video signal is a wide color gamut signal including a signal deviated from the narrow color gamut, whereas if it is determined that the input video signal is not the wide color gamut signal, the input video signal is a narrow color gamut signal. θₐ and θᵣ are beforehand set to appropriate values. These chromaticity calculations are performed on a plurality of image frames (the number of frames=nt) (see FIG. 10). By this processing, the influence of an image frame including only narrow-gamut pixel values, which will occasionally occur, is prevented.

After determining the color gamut in step ST4, the program proceeds to step ST5. In step ST5, the color gamut increasing unit 5 receives the result of color gamut determination from the color gamut determining unit 4. If the answer is Yes, the program proceeds to step ST6, while if the answer is No, the program proceeds to step ST7.

In step ST6, the color gamut increasing unit 5 performs gamut increase processing on each narrow-gamut (e.g., BT.709 gamut) pixel included in the video signal to thereby create a wide-gamut (e.g., BT.2020 gamut) pixel, followed by the program proceeding to step ST7.

In step ST7, the color gamut increasing unit 5 outputs a pixel-processed video signal, followed by the program proceeding to step ST8.

In step ST8, it is determined whether input of the video signal has finished. If the input has finished (Yes in step ST8), the processing is finished, whereas if it has not yet finished (No in step ST8), the program returns to step ST1 to thereby iterate the above-mentioned steps ST2 to ST7.

By virtue of the above processing, in the first embodiment, even when the attribute information of a video signal includes no original color gamut information, the original color gamut is determined from each pixel value of the input video signal, and color gamut increase processing is performed adaptively based on the determination result. As a result, display can be performed with preferable colors faithful to materials.

### Second Embodiment

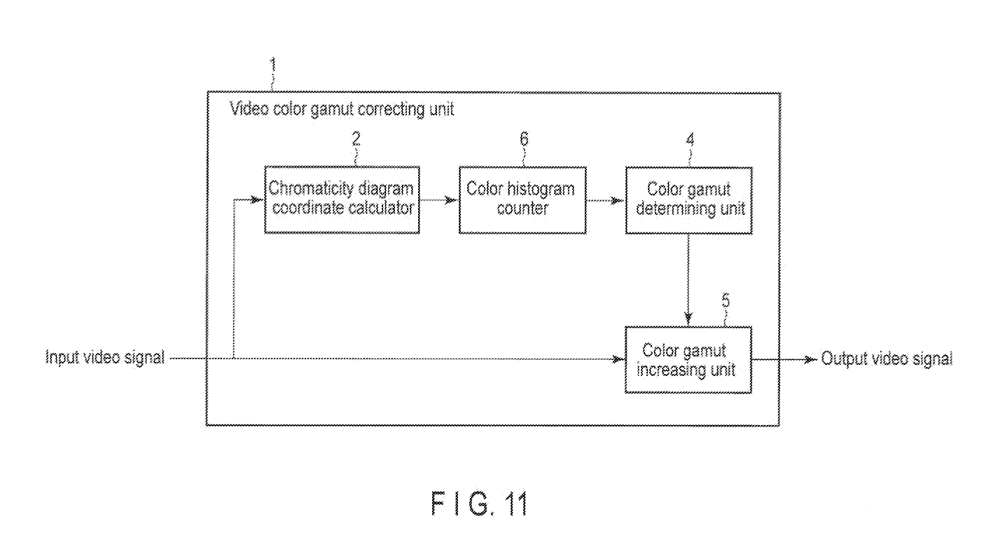

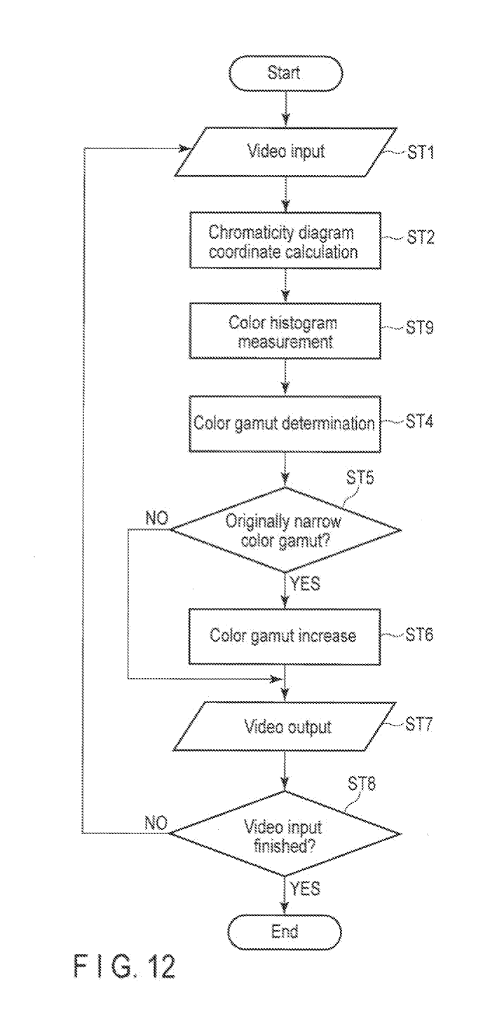

Referring now to FIGS. 11 to 14, a description will be given of video color gamut correction performed in a video reproduction apparatus (the video data processor 132 in FIG. 1) according to a second embodiment, employed in the system 100 of FIG. 1. In FIGS. 11 and 12, elements similar to those of FIGS. 2 and 3 are denoted by corresponding reference numbers, and no detailed description will be given thereof.

FIG. 11 is a block diagram showing the configuration of a video color gamut correcting unit 1 employed in the video reproduction apparatus of the second embodiment. The video color gamut correcting unit 1 shown in FIG. 11 differs from the video color gamut correcting unit 1 of FIG. 2 in that the former employs a color histogram counter 6 instead of the deviation determining unit 3.

The color histogram counter 6 receives a video signal having its chromaticity diagram coordinates calculated by the chromaticity coordinate calculator 2. The color histogram counter 6 determines within which one of the corresponding color ranges (bins) included in predetermined color bins, the color indicated by each pixel value of the input video signal falls, adds the chromaticity of the determined bin, and outputs addition results of the respective bins as a color histogram to the color gamut determining unit 4.

Referring then to FIGS. 12 to 14, a description will be given of a procedure of processing performed in the video color gamut correcting unit 1 constructed as the above.

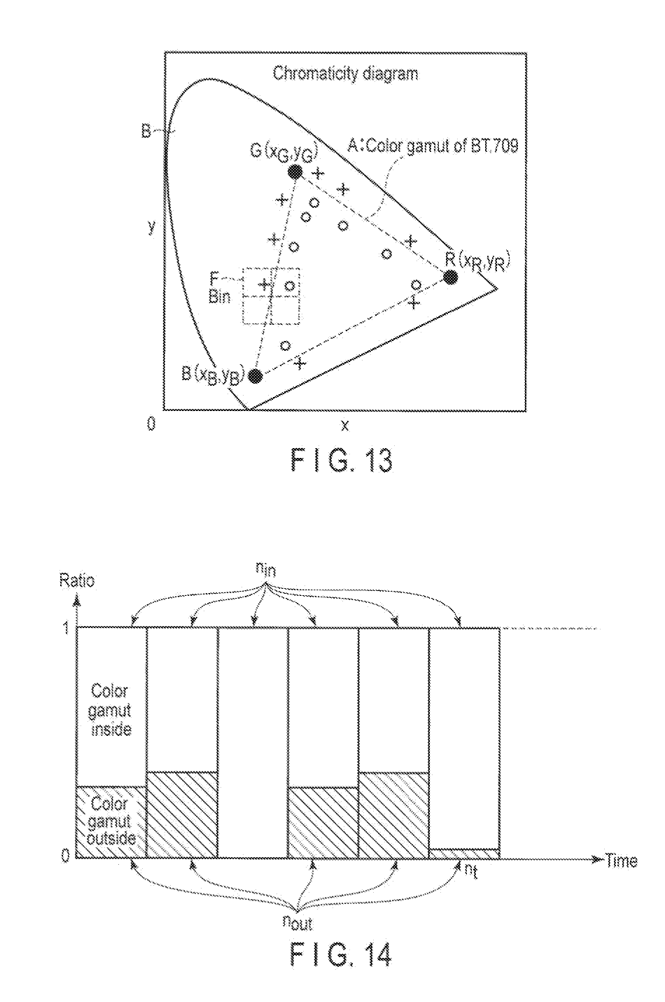

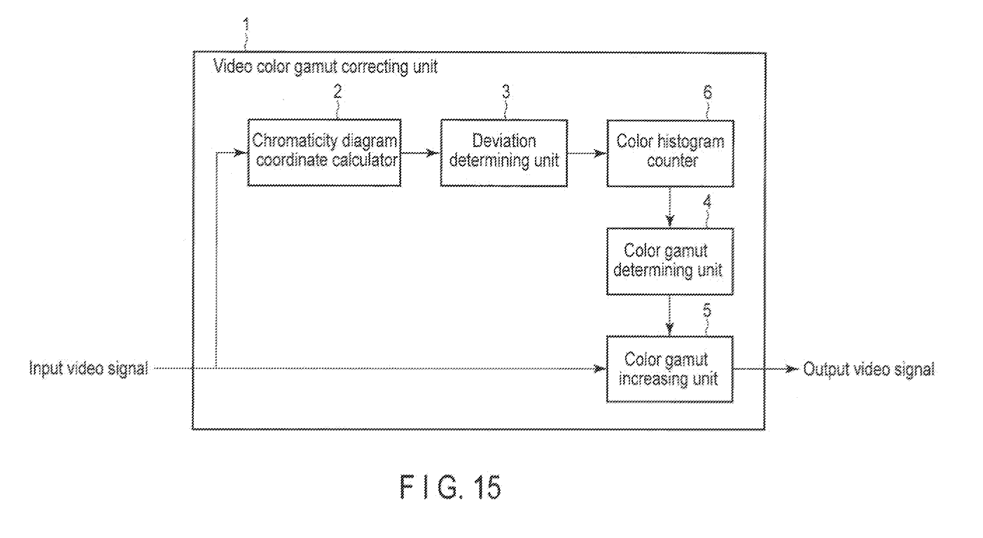

FIG. 12 is a flowchart showing a procedure of color gamut increase processing performed by the video color gamut correcting unit 1 of FIG. 11, FIG. 13 is a conceptual diagram showing a predetermined color bin on a chromaticity diagram, and FIG. 14 is a conceptual diagram showing a color histogram of image frames expressed using the ratio.

The procedure shown in FIG. 12 differs from the procedure of the color gamut increase processing shown in FIG. 3 in that the former employs a color histogram measuring process in step ST19, instead of the deviation determination in step ST3.

More specifically, in step ST19, the color histogram counter 6 determines within which one of bins corresponding to predetermined color ranges, the color indicated by each pixel value of a video signal falls, and adds the chromaticity of the determined bin. In FIG. 13, F indicates a color range, i.e., a bin. After completing the color histogram counting in step ST19, the program proceeds to step ST4.

In step ST4, the color gamut determining unit 4 determines the color gamut corresponding to an input video signal, using count result information received from the color histogram counter 6. In the second embodiment, assuming that Bᵢ is the i^{th} bin, Cᵢₙ is a set of bins within a color gamut, and Cₒᵤₜ is a set of bins outside the color gamut, the sum of the chromaticities nᵢ of the bins belonging to Cᵢₙₙ within a narrow color gamut is counted and set as nᵢₙ (see the following equation (17)), and the sum of the chromaticities nᵢ of the bins belonging to Cₒᵤₜ outside the narrow color gamut is counted and set as nₒᵤₜ (see the following equation (18)).

$$\begin{matrix}{n}_{in} = {\sum }_{{B}_{i} ∈ {C}_{in}} {n}_{i} & ( 17 ) \\ {n}_{out} = {\sum }_{{B}_{i} ∈ {C}_{out}} {n}_{i} & ( 18 )\end{matrix}$$

Alternatively, in order to smoothly shift the determination result in the vicinity of the boundary of the color gamut, the ratio of bins i within the gamut may be set as wᵢⁱⁿ, and the ratio of bins i outside the gamut be set as wᵢ^{out}, thereby calculating nᵢₙ and nₒᵤₜ, using the following equations (19) to (21):

$$\begin{matrix}{n}_{in} = {\sum }_{i} {w}_{i}^{in} {n}_{i} & ( 19 ) \\ {n}_{out} = {\sum }_{i} {w}_{i}^{out} {n}_{i} & ( 20 ) \\ {w}_{i}^{in} + {w}_{i}^{out} = 1 & ( 21 )\end{matrix}$$

If nₒᵤₜ is greater than θₐ (see FIG. 8), if the chromaticity of each bin belonging to Cₒᵤₜ or the maximum value of wᵢ^{out}*nᵢ is greater than θₐ (see FIG. 10), and if nₒᵤₜ/(nᵢₙ+nₒᵤₜ) is greater than θᵣ (see FIG. 9), it is determined that the video signal is a wide gamut signal, while if not, the video signal is determined to be a narrow gamut signal. θₐ and θᵣ are beforehand set to appropriate values. These chromaticity calculations are performed for each of a plurality of image frames (the number of frames=nt) (see FIG. 14).

By virtue of the above processing procedure, also in the second embodiment, even when the attribute information of a video signal includes no original color gamut information, the original color gamut is determined from each pixel value of the input video signal, and color gamut increase processing is performed adaptively based on the determination result. As a result, display can be performed with preferable colors faithful to materials.

In FIG. 11, the video color gamut correcting unit 1 employs the color histogram counter 6, instead of the deviation determination unit 3. However, the color histogram counter 6 may be provided after the deviation determination unit 3 so that color histogram counting will be performed on pixels outside the gamut, which are deviated at least from the deviation determination result. This processing can also be implemented like the second embodiment.

### Third Embodiment

A third embodiment is obtained by adding, to the first embodiment, processing of performing scene change detection of an input video signal to change color gamut increase processing at appropriate timing, based on the detection result. In this embodiment, no detailed description will be given of the elements that perform the same processing as in the first embodiment.

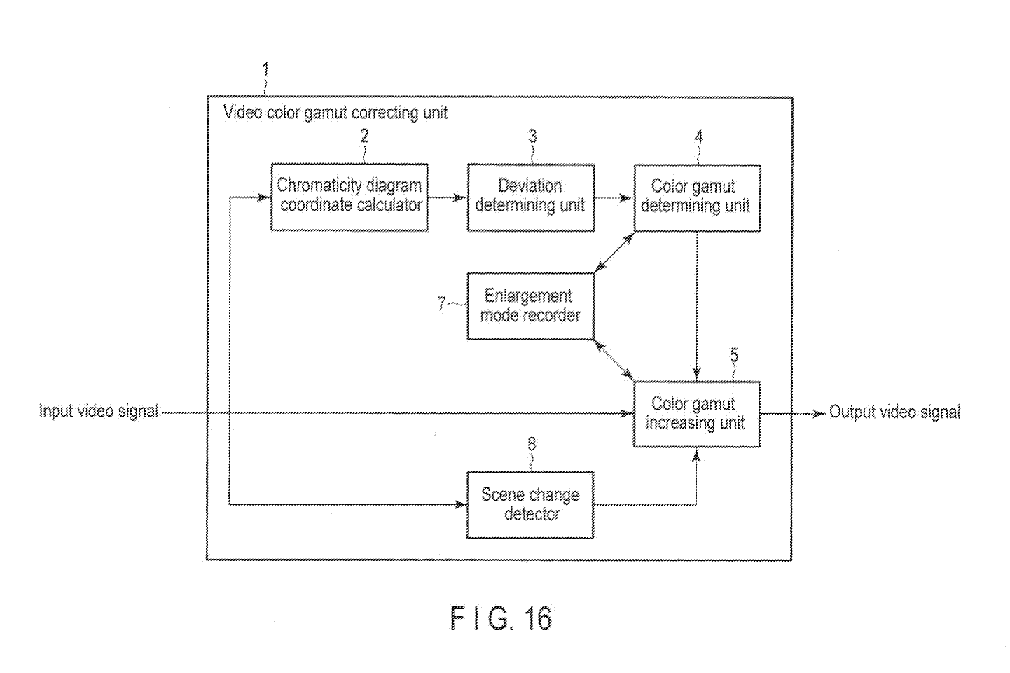

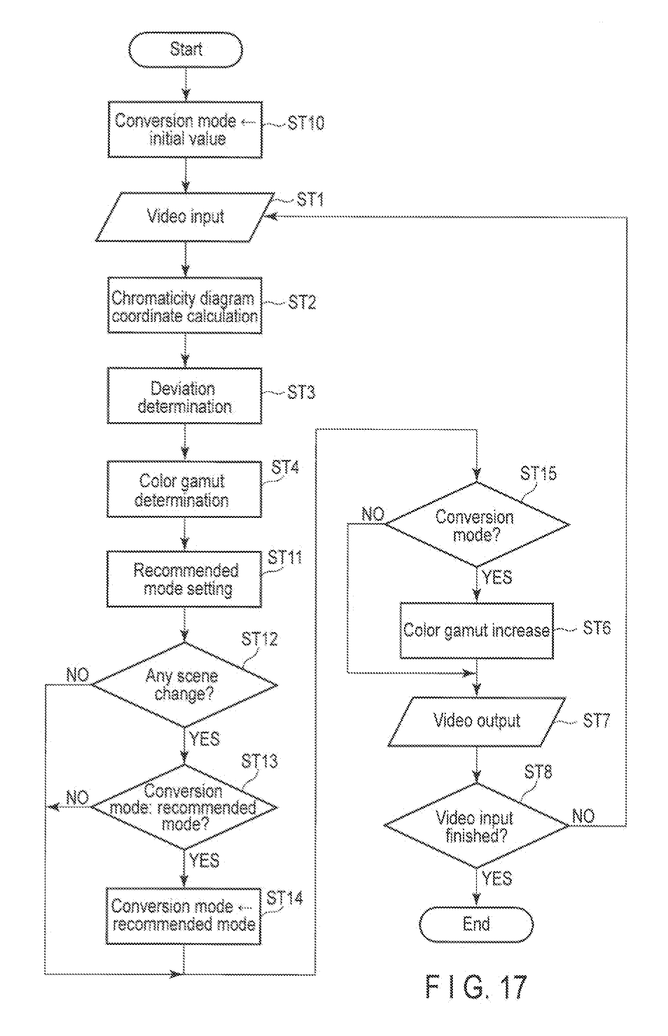

FIG. 16 is a block diagram showing the configuration of a video color gamut correcting unit 1 employed in the third embodiment, and FIG. 17 is a flowchart for explaining the operation of the third embodiment.

The video color gamut correcting unit 1 of FIG. 16 differs from the video color gamut correcting unit 1 of the first embodiment shown in FIG. 2 in that the former additionally employs an enlargement mode recorder 7 and a scene change detector 8. The enlargement mode recorder 7 beforehand records a plurality of enlargement modes of different processing content for color gamut increase, and provides the color gamut increasing unit 5 with a recommended mode for color gamut increase processing, based on the color gamut determination result of the color gamut determining unit 4. The scene change detector 8 detects the position of a scene change in an input video signal, and sends a scene change detection signal to the color gamut increasing unit 5 so that switching of processing will be performed at the detected position. The term “scene change” means a discontinuous scene change in a continuous video sequence, i.e., switching of scenes.

FIG. 17 shows a processing procedure employed in the third embodiment. The procedure of FIG. 17 differs from that of the first embodiment shown in FIG. 3 in that in the former, step ST5 is deleted and steps ST10 to ST15 are added.

In FIG. 17, in step ST10, the color gamut increasing unit 5 sets a conversion mode to an appropriate initial value, and reports the set value to the enlargement mode recorder 7. As the initial value of the conversion mode, a value indicative of “enlargement,” “No conversion,” etc., is set. After step ST10, the program proceeds to subsequent step ST1, where it is determined whether there is a video signal input. After that, in steps ST2, ST3 and ST4, chromaticity diagram coordinate calculation, deviation determination and color gamut determination are performed, respectively, and then the program proceeds to step ST11.

In step ST11, the color gamut determination unit 4 sets “enlargement” as a recommended mode if the color gamut determination result indicates a narrow color gamut, and sets “No conversion” as the recommended mode if the color gamut determination result indicates a wide color gamut. The set recommended mode is reported to the enlargement mode recorder 7. After that, the program proceeds to step ST12.

In step ST12, the scene change detector 8 detects whether a scene change associated with the input video signal has occurred, and reports the determination result to the color gamut increasing unit 5. If a scene change has been detected, the program proceeds to step ST13, while if no scene change has been detected, the program proceeds to step ST15.

The determination as to the above-mentioned scene change is performed in the following way: A statistics value, such as an average luminance value or a luminance variance, is calculated for each image frame, and the distance in statistics value between two subsequent image frames is calculated. If the distance had exceeded a preset threshold, it is determined that a scene change has occurred. For instance, if the following inequality is satisfied, it is determined that a scene change has occurred.

(Y₁−Y₂)²+(s₁−s₂)²×θ

where Y₁ is the average luminance value of a first image frame, s₁ is a variance associated with the first image frame, Y₂ is the average luminance value of a first image frame, s₂ is a variance associated with the second image frame, and θ is a threshold.

There is another method, in which the pixel values at preset particular coordinate pairs can be directly used as statistic values. Further, in the case of a color image, pixel values (luminance Y and color differences (U, V)) can be used as three-dimensional values. Yet further, a color histogram is calculated from pixel values, and a scene change can be detected from differences in the thus-calculated color histogram.

In step ST13, the color gamut increasing unit 5 compares the conversion mode with the recommended mode stored in the enlargement mode recorder 7. If they differ from each other, the recommended mode is substituted for the conversion mode (step ST14), and the program proceeds to step ST15. In contrast, if the conversion mode (value) is equal to the recommended mode (value), the program directly proceeds to step ST15.

In step ST15, the color gamut increasing unit 5 checks the content of the conversion mode. If it is “enlargement,” the program proceeds to step ST6, while if it is “No conversion,” the program proceeds to step ST7.

In step ST6, the color gamut increasing unit 5 performs color gamut increase processing on the input video signal, followed by the program proceeding to step ST7.

In the third embodiment, since a scene change in an input video signal is detected, and the timing of change in color gamut processing is controlled based on the detection result, a sense of visual discomfort due to the change of color gamut processing can be reduced.

As described above, in color gamut increase processing performed in the embodiments, appropriate color gamut increase processing is adaptively performed in a real time on both a video image created in a narrow color gamut and a video image created in a wide color gamut, thereby outputting video images faithful to materials, exhibiting clean colors, and imparting natural impression.

The above-described embodiments can also be implemented as video display apparatuses including a wide-color-gamut compliant display.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video reproduction apparatus comprising:
a chromaticity diagram coordinate calculator which calculates two-dimensional coordinate data of an input video signal on a chromaticity diagram;
a color gamut determining unit which compares the two-dimensional coordinate data calculated by the chromaticity diagram coordinate calculator, with a preset standard color gamut on the chromaticity diagram, and determines, based on a result of the comparison, whether a color gamut corresponding to the input video signal falls within the standard color gamut; and
a color gamut increasing unit which adjusts color gamut increase processing and performs the adjusted color gamut increase processing on the input video signal, based on a determination result of the color gamut determining unit.

2. The video reproduction apparatus according to claim 1, wherein the color gamut determining unit further determines whether the two-dimensional coordinate data falls within or outside the standard color gamut on the chromaticity diagram, and determines the color gamut corresponding to the input video signal, based on a result of the determination.

3. The video reproduction apparatus according to claim 1, wherein the color gamut determining unit determines which one of bins located within and outside the standard color gamut on the chromaticity diagram corresponds to the two-dimensional coordinate data, to count chromaticities of an inside and an outside of the standard color gamut and form a color histogram, and determines the color gamut corresponding to the input video signal, based on the color histogram.

4. The video reproduction apparatus according to claim 1, wherein the color gamut determining unit determines whether the two-dimensional coordinate data falls within or outside the standard color gamut, counts chromaticities corresponding to at least part of the two-dimensional coordinate data that falls outside the standard color gamut to form a color histogram, and determines the color gamut corresponding to the input video signal, based on the color histogram.

5. The video reproduction apparatus according to claim 1, further comprising:
a detector which detects a scene change in the input video signal; and
a mode recorder used to select one of a plurality of modes as content of the color gamut processing by the color gamut increasing unit, based on a determination result of the color gamut determining unit,
wherein the color gamut increasing unit performs switching to a mode for a color gamut increase based on an instruction from the mode recorder, when the detector has detected the scene change.

6. A video reproduction method comprising:
calculating two-dimensional coordinate data of an input video signal on a chromaticity diagram;
comparing the two-dimensional coordinate data with a preset standard color gamut on the chromaticity diagram, and determining, based on a result of the comparison, whether a color gamut corresponding to the input video signal falls within the standard color gamut; and
adjusting color gamut increase processing and performs the adjusted color gamut increase processing on the input video signal, based on a result of the determination.

7. The video reproduction method according to claim 6, wherein the determining includes determining whether the two-dimensional coordinate data falls within or outside the standard color gamut on the chromaticity diagram, and determining the color gamut corresponding to the input video signal, based on a result of the determination.

8. The video reproduction method according to claim 6, wherein the determining includes determining which one of bins located within and outside the standard color gamut on the chromaticity diagram corresponds to the two-dimensional coordinate data, to count chromaticities of an inside and an outside of the standard color gamut and form a color histogram, and determining the color gamut corresponding to the input video signal, based on the color histogram.

9. The video reproduction method according to claim 6, wherein the determining includes determining whether the two-dimensional coordinate data falls within or outside the standard color gamut, counting chromaticities corresponding to at least part of the two-dimensional coordinate data that falls outside the standard color gamut to form a color histogram, and determining the color gamut corresponding to the input video signal, based on the color histogram.

10. The video reproduction method according to claim 6, further comprising:
detecting a scene change in the input video signal; and
selecting a mode as content of the color gamut increase processing from a plurality of modes, based on a result of the determination, when the scene change has been detected.

11. A video display apparatus comprising:
a chromaticity diagram coordinate calculator which calculates two-dimensional coordinate data of an input video signal on a chromaticity diagram;
a color gamut determining unit which compares the two-dimensional coordinate data calculated by the chromaticity diagram coordinate calculator, with a preset standard color gamut on the chromaticity diagram, and determines, based on a result of the comparison, whether a color gamut corresponding to the input video signal falls within the standard color gamut;
a color gamut increasing unit which adjusts color gamut increase processing and performs the adjusted color gamut increase processing on the input video signal, based on a determination result of the color gamut determining unit; and
a wide-gamut-compliant display which displays a video signal output from the color gamut increasing unit, in a color gamut wider than the standard color gamut.

12. The video display apparatus according to claim 11, wherein the color gamut determining unit further determines whether the two-dimensional coordinate data falls within or outside the standard color gamut on the chromaticity diagram, and determines the color gamut corresponding to the input video signal, based on a result of the determination.

13. The video display apparatus according to claim 11, wherein the color gamut determining unit determines which one of bins located within and outside the standard color gamut on the chromaticity diagram corresponds to the two-dimensional coordinate data, to count chromaticities of an inside and an outside of the standard color gamut and form a color histogram, and determines the color gamut corresponding to the input video signal, based on the color histogram.

14. The video display apparatus according to claim 11, wherein the color gamut determining unit determines whether the two-dimensional coordinate data falls within or outside the standard color gamut, counts chromaticities corresponding to at least part of the two-dimensional coordinate data that falls outside the standard color gamut to form a color histogram, and determines the color gamut corresponding to the input video signal, based on the color histogram.

15. The video display apparatus according to claim 11, further comprising:
a detector which detects a scene change in the input video signal; and
a mode recorder used to select one of a plurality of modes as content of the color gamut processing by the color gamut increasing unit, based on a determination result of the color gamut determining unit,
wherein the color gamut increasing unit performs switching to a mode for a color gamut increase based on an instruction from the mode recorder, when the detector has detected the scene change.
